(19) United States
(12) Patent Application Publication
(10) Pub. No.: US 2021/0350718 A1
(43) Pub. Date: Nov. 11, 2021

(54) Method And Apparatus For Aircraft Navigation

(71) Applicants: Richard Redpath, Cary, NC (US); James Redpath, Cary, NC (US)

(72) Inventors: Richard Redpath, Cary, NC (US); James Redpath, Cary, NC (US)

(21) Appl. No.: 16/840,391

(22) Filed: Apr. 5, 2020

(51) Int. Cl. G08G 5/06

(52) U.S. Cl. CPC G08G 5/065

(57) ABSTRACT

The apparatus is designed to provide a laser line for aircraft navigation for apron management services on the apron area. The invention is designed to have a laser line that is intended to be used by apron management service to guide and park an aircraft.

### BACKGROUND OF THE INVENTION

This application claims the benefit of U.S. Patent Application No. 62/843390 entitled “A Method And Apparatus For Aircraft Apron Navigation” filed May 4 2019.

### FIELD OF THE INVENTION

The present invention relates generally to aircraft parking and moving, more particularly an apparatus that uses laser light for airport apron management service to park aircraft. A user of the present invention will be able to manufacture an apparatus that uses a laser that is mounted on an aircraft to guide the aircraft on the apron area.

The apron is a defined area on an airport intended to accommodate aircraft for purposes of loading or unloading passengers or cargo, refueling, parking, or maintenance. The apron is designated by the ICAO as not being part of the maneuvering area aerodrome to be used by aircraft for takeoff, landing, and taxiing. All vehicles, aircraft and people using the apron are referred to as apron traffic. The traffic is guided by apron management service staff. It is standard for apron management staff to use light wands and hand paddles for signaling the pilot to assist in navigating the aircraft. It is common to see a painted line on the apron for which the pilot is to guide the aircraft front wheel to park given signals from the apron management staff to the pilot. At dusk/night and inclement weather it is more difficult for the pilot to navigate the aircraft precisely compared to day operation.

Furthermore, pilots can have trouble seeing the runway as they approach the airport for landing. The pilot of a single-engine plane crashed in 2019 as he approached Raleigh-Durham International Airport from the wooded 5600 acre Umstead State Park with visibility more than 10 miles under overcast skies. The pilot reported to the airport's control tower that the runway was in sight, according to the National Transportation Safety Board. On the final approach the pilot apparently clipped a tree and crashed.

Therefore, the object of the present invention is a seamless solution to provide the pilot the exact direction of the aircraft maneuvering body position. The present invention is to provide a laser line by the pilot to convey maneuver body position to apron service management. In addition, the pilot can actually see the laser line on the guiding apron area painted line to aid navigation precisely. Furthermore, the pilot can use such invention to scan for the tree line when approaching the airport to land.

### BRIEF DESCRIPTION OF THE DRAWINGS

FIG. 1 is a diagram illustrating using the invention by the pilot on the apron.

FIG. 2 is a diagram illustrating using the invention by the aircraft for the apron.

FIG. 3 is a diagram illustrating using the invention by the aircraft for object avoidance.

### DETAIL DESCRIPTIONS OF THE INVENTION

All illustrations of the drawings are for the purpose of describing selected versions of the present invention and are not intended to limit the scope of the present invention.

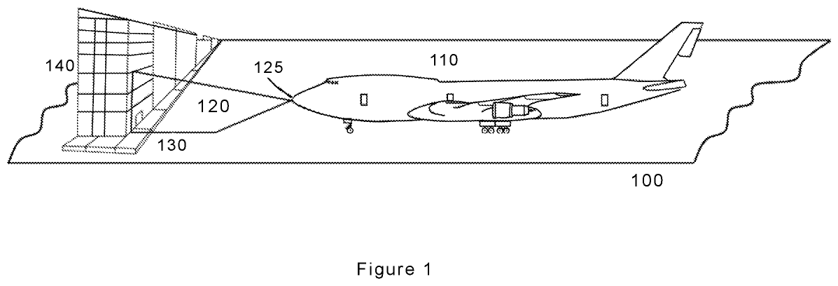

Referring to FIG. 1 at 100 is an airport apron the area of an airport where aircraft are parked, unloaded or loaded, refueled, or boarded. At 110 is an aircraft with laser line apparatus mounted at 125 commonly where an LED lamp is mounted today. The laser produces a vertical laser plane at 120 which creates a laser line along the tarmac at 130 and the building at 140. The laser line is collocated in the direction of the aircraft maneuvering position body forward the aircraft at 110 for guidance.

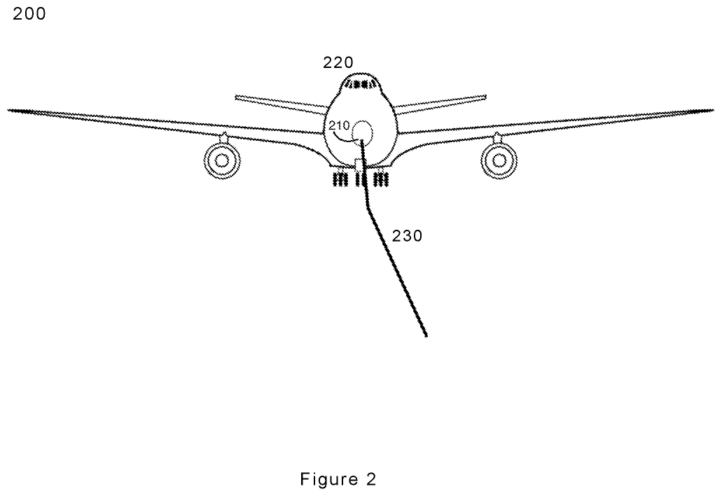

Referring to FIG. 2 at 200 is diagrammed an Aircraft at 220 using a laser line apparatus mounted at 210 and collated in the direction of the aircraft maneuvering position body forward. The laser apparatus mounted at 210 projects a laser line at 230 forward the aircraft at 220.

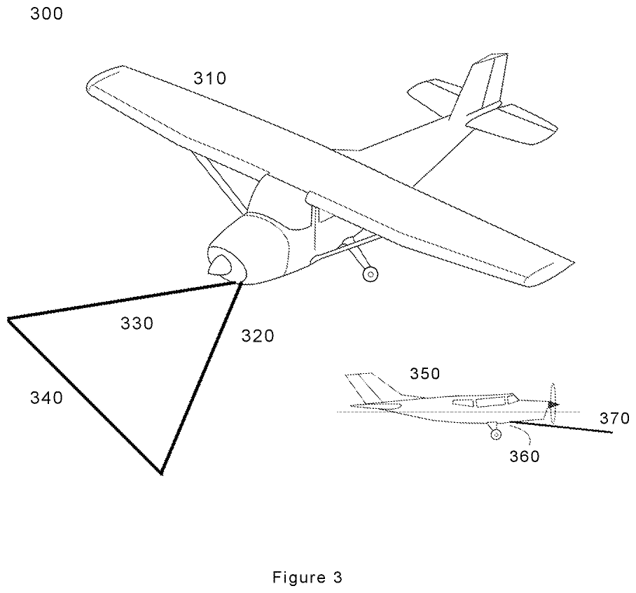

Referring to FIG. 3 at 300 is a small flying aircraft. At 320 is a laser line apparatus mounted to produce a horizontal laser plane less than 10 degrees from the aircraft bottom plane to sweep the laser plane at 330 forward the aircraft to produce a horizontal line at 340. At 350 is a side view of the aircraft to show the angle of the laser line apparatus less then 10 degrees mounted at 360 for a laser plane at 370 to sweep forward the plane at 350. This sweeping forward will provide the pilot visual signals of objects forward the aircraft such as trees for its approach to landing during dark hours or inclement weather.

Although the invention has been explained in relation to its preferred embodiment, it is to be understood that many other possible modifications and variations can be made without departing from the spirit and scope of the invention.

What is claimed is:

1. A method and apparatus for aircraft navigation wherein:
an apparatus providing a vertical laser line light source;
said apparatus being mounted on the aircraft to signal the body direction for maneuvering the aircraft on the apron area.

2. A method and apparatus for aircraft navigation wherein:
an apparatus providing a laser plane light source;
said apparatus being mounted on the aircraft set less than 10 degrees from the airplane bottom plane to sweep a laser plane of light forward the aircraft travel direction for visual signals of objects in its path to the pilot.

3. A method and apparatus for aircraft navigation in claim 2:
said apparatus can actively adjust the angle of the laser line plane to scan forward the aircraft;
